(19) United States
(12) Patent Application Publication
(10) Pub. No.: US 2005/0167134 A1
(43) Pub. Date: Aug. 4, 2005

(54) Heating cable substantially free from electromagnetic field

(76) Inventor: Philippe Charron, Boucherville (CA)

Correspondence Address: FAY KAPLUN & MARCIN, LLP, 15O BROADWAY, SUITE 702, NEW YORK, NY, 10038, US

(21) Appl. No.: 10/770,244

(22) Filed: Feb. 2, 2004

(51) Int. Cl. H01B 7/29

(52) U.S. Cl. 174/36

(57) ABSTRACT

A heating cable is substantially free from electromagnetic field, and comprises a pair or spirally twisted heating wire elements, a tubular sheath made of electrically conductive material covering the pair of spirally twisted heating wire elements, and possibly an insulating jacket covering the tubular sheath. When the spirally twisted heating wire elements are supplied with a current of given amplitude flowing in opposite directions in the heating wire elements, the electromagnetic fields from the respective wire elements cancel each other to provide a heating cable substantially free from electromagnetic field. A method of fabricating the heating cable is also disclosed.

### FIELD OF THE INVENTION

The present invention relates to a heating cable designed for producing substantially no electromagnetic field.

### BACKGROUND OF THE INVENTION

It is known to distribute heating cables on the plywood surface of an unfinished floor as a heating system for the corresponding room. Once the heating cables have been laid out, a grout mixture is poured and uniformly spread over the plywood surface to cover the heating cables. The resulting floor surface can be finished by installing, for example, ceramic tiles, engineered wood flooring, vinyl flooring, etc.

A problem encountered with heating cables is that they produce electromagnetic field that some allege may eventually cause health problems. Scientists at Health Canada are aware that some studies have suggested a possible link between ELF (Extremely Low Frequency) field exposure and certain types of childhood cancer.

One type of heating cables comprise a pair of parallel heating wire elements through which electric current flows in opposite directions. It has been determined that placing two heating wire elements in parallel is not sufficient to eliminate the problematic electromagnetic field.

Consequently, there is a need for a heating cable free from electromagnetic field.

### SUMMARY OF THE INVENTION

Accordingly, the present invention relates to a heating cable substantially free from electromagnetic field, comprising a pair or spirally twisted heating wire elements, and a tubular sheath made of electrically conductive material covering the pair of spirally twisted heating wire elements. When the spirally twisted heating wire elements are supplied with a current of given amplitude flowing in opposite directions in the heating wire elements, the electromagnetic fields from the respective wire elements cancel each other to provide a heating cable substantially free from electromagnetic field.

The present invention also relates to a method of fabricating a heating cable substantially free from electromagnetic field, comprising spirally twisting a pair of heating wire elements together, and covering the pair of spirally twisted heating wire elements with a tubular sheath made of electrically conductive material. Again, when the spirally twisted heating wire elements are supplied with a current of given amplitude flowing in opposite directions in the heating wire elements, the electromagnetic fields from the respective wire elements cancel each other to provide a heating cable substantially free from electromagnetic field.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a cross-sectional view, taken along line 2-2 of FIG. 2, of a non-restrictive illustrative embodiment of the heating cable according to the present invention, substantially free from electromagnetic field;

FIG. 2 is a side elevational view of the non-restrictive illustrative embodiment of heating cable as shown in FIG. 1; and

FIG. 3 is a side elevational view of a section of a pair of spirally twisted heating wire elements of the heating cable of FIGS. 1 and 2, showing the lay of these spirally twisted heating wire elements.

### DETAILED DESCRIPTION OF THE ILLUSTRATIVE EMBODIMENTS

The non-restrictive illustrative embodiment of the heating cable according to the present invention, substantially free from electromagnetic field, will now be described in connection with the appended drawings.

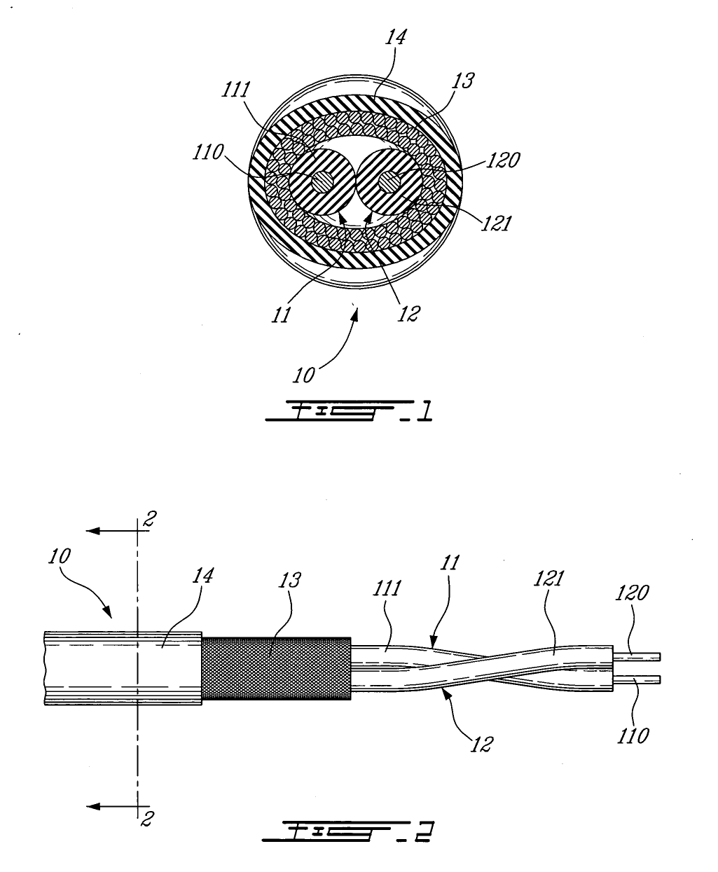

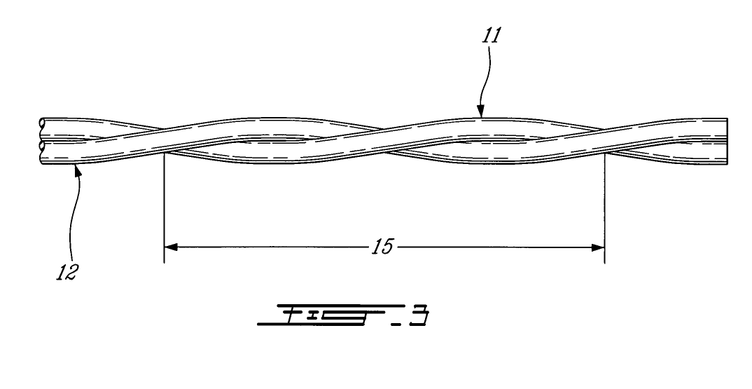

As illustrated in FIGS. 1 and 2, the heating cable substantially free from electromagnetic field is generally designated by the reference 10. This heating cable 10 comprises:
a pair of spirally twisted heating wire elements 11 and 12;
a metal sheath 13 covering the pair of spirally twisted heating wire elements 11 and 12; and
an insulating jacket 14 covering the metal sheath 13.

Heating Wire Element 11

The heating wire element 11 comprises a resistance wire 110 whose electrical resistance (resistance by unit of length of resistance wire) is adjusted to produce heat when supplied with an electric current. For example, the electrical resistance of the resistance wire 110 can be adjusted, taking into consideration the total length of the heating wire element 11 in a typical installation, to release a given amount of heat when supplied with alternating current from, for example, a 120-Volt 60-Hz voltage source commonly found in residential, industrial and commercial buildings.

For example, the electrical resistance of the resistance wire 110 can be adjusted by adjusting the diameter thereof.

Although the wire 110 can be made of copper, it is within the scope of the present invention to use a wire 110 made of another electrically conductive material, for example made of an electrically conductive metal other than copper, or an electrically conductive metal alloy including copper and/or any other suitable metal(s).

Still referring to FIGS. 1 and 2, the wire 110 is individually insulated by means of electrical insulation 111. Insulation 111 can be made of extruded plastic material such as polyethylene or polypropylene capable of withstanding and conducting the heat generated by and released from the wire 110.

Heating Wire Element 12

In the herein disclosed non-restrictive illustrative embodiment, the heating wire element 12 is substantially similar to the heating wire element 11.

Therefore, the heating wire element 12 is formed of a resistance wire 120 individually insulated by means of electrical insulation 121. Insulation 121 can be made of extruded plastic material such as polyethylene or polypropylene capable of withstanding and conducting the heat generated by and released from the wire 120.

The resistance wire 120 has an electrical resistance (resistance by unit of length of resistance wire) adjusted to produce heat when supplied with an electric current. For example, the electrical resistance of the resistance wire 110 can be adjusted, taking into consideration the total length of the heating wire element 11 in a typical installation, to release a given amount of heat when supplied with alternating current from, for example, a 120-Volt 60-Hz voltage source commonly found in residential, industrial and commercial buildings.

For example, the electrical resistance of the resistance wire 120 can be adjusted by adjusting the diameter thereof.

Although the wire 120 can be made of copper, it is within the scope of the present invention to use a wire 120 made of another electrically conductive material, for example made of an electrically conductive metal other than copper, or an electrically conductive metal alloy including copper and/or any other suitable metal(s).

As better shown in FIG. 3, the heating wire elements 11 and 12 are spirally twisted with a given lay 15. The lay 15 corresponds to the length required by the heating wire elements 11 and 12 to be spirally twisted by 1 turn.

It has been found that, by spirally twisting the heating wire elements 11 and 12, the electromagnetic field from the heating wire element 11 and the electromagnetic field from the heating wire element 12 cancel each other, of course when the current has the same given amplitude in the two heating wire elements 11 and 12, and the current flowing through the heating wire element 11 flows in a direction opposite to the current flowing through the heating wire element 12. A lay 15 having a length equal to or shorter than 2 inches, for example 1⅝ inch long, has proved to be efficient in canceling the electromagnetic field.

Metal Sheath 13

The metal sheath 13 is formed of a plurality of small-diameter electrically-conductive metal wires braided together to form a tubular shielding and/or an electrically-conductive metal tape spirally wound or longitudinally applied to the pair of spirally twisted heating wire elements. A first function of the metal sheath 13 is to ground the heating cable 10 through a connection to the ground. A second function of the metal sheath 13 is to mechanically resist to impacts as strong as 100 lbs, the metal sheath 13 being designed for that purpose.

Again, although the braided metal wires or the metal tape can be made of copper, it is within the scope of the present invention to use another electrically conductive material, for example an electrically conductive metal other than copper, or an electrically conductive metal alloy including copper and/or any other suitable metal(s).

Of course, the metal sheath 13 will comprise braided wires and/or tape made of a material capable of withstanding and conducting the heat generated by and released from the wires 110 and 120.

It is within the scope of the present invention to use a tubular metal sheath of any suitable type other than a braided metal sheath or tape.

Insulating Jacket 14

The insulating jacket 14 covering the metal sheath 13 can be made of extruded plastic or elastomeric material with or without subsequent cross-linking such as polyethylene or polypropylene capable of withstanding and conducting the heat generated by and released from the wires 110 and 120.

The function of the insulating jacket 14 is to electrically insulate the metal sheath 13 from any surrounding structures.

However, in certain embodiments, no insulating jacket 14 is required. As a non-limitative example, a heating cable 10 comprising a sheath 13 made of stainless steel will require no insulating jacket 14.

Although the present invention has been described hereinabove by way of a non-restrictive illustrative embodiment thereof, this embodiment can be modified at will, within the scope of the appended claims, without departing from the spirit and scope of the present invention.

1. A heating cable substantially free from electromagnetic field, comprising:
a pair or spirally twisted heating wire elements; and
a tubular sheath made of electrically conductive material covering the pair of spirally twisted heating wire elements;
wherein, when the spirally twisted heating wire elements are supplied with a current of given amplitude flowing in opposite directions in the heating wire elements, the electromagnetic fields from the respective wire elements cancel each other to provide a heating cable substantially free from electromagnetic field.

2. A heating cable substantially free from electromagnetic field as defined in claim 1, further comprising:
an insulating jacket covering the tubular sheath.

3. A heating cable substantially free from electromagnetic field as defined in claim 1, wherein:
the tubular sheath comprises a metal sheath.

4. A heating cable substantially free from electromagnetic field as defined in claim 1, wherein:
each heating wire element comprises an electrically insulated wire made of electrically conductive material and having an electrical resistance adjusted to produce heat when the wire is supplied with an electric current.

5. A heating cable substantially free from electromagnetic field as defined in claim 1, wherein
the insulating jacket is made of extruded plastic material capable of withstanding and conducting heat generated by and released from the heating wire elements.

6. A heating cable substantially free from electromagnetic field as defined in claim 3, wherein:
the metal sheath includes a plurality of small-diameter wires braided together to form the tubular sheath.

7. A heating cable substantially free from electromagnetic field as defined in claim 3, wherein:
the metal sheath includes a metal tape spirally wound or longitudinally applied to the pair of spirally twisted heating wire elements.

8. A heating cable substantially free from electromagnetic field as defined in claim 6, wherein:
the small-diameter wires of the metal sheath are made of an electrically conductive material capable of withstanding and conducting the heat generated by and released from the heating wire elements.

9. A heating cable substantially free from electromagnetic field as defined in claim 7, wherein:
the metal tape of the metal sheath is made of an electrically conductive material capable of withstanding and conducting the heat generated by and released from the heating wire elements.

10. A heating cable substantially free from electromagnetic field as defined in claim 3, wherein:
the metal sheath forms a ground conductor for grounding the heating cable through a connection to the ground.

11. A heating cable substantially free from electromagnetic field as defined in claim 5, wherein:
the extruded plastic material forming the insulating jacket is selected from the group consisting of: polyethylene and polypropylene.

12. A heating cable substantially free from electromagnetic field as defined in claim 1, wherein:
the pair of spirally twisted heating wire elements are supplied with alternating current; and
the pair of heating wire elements are spirally twisted with a lay having a length equal to or shorter than 2 inches.

13. A heating cable substantially free from electromagnetic field as defined in claim 1, wherein:
the tubular sheath is designed for connection to the ground in view of grounding the heating cable; and
the electrically conductive material of the tubular sheath is sufficiently resistant to support impacts as strong as 100 lbs.

14. A method of fabricating a heating cable substantially free from electromagnetic field, comprising:
spirally twisting a pair of heating wire elements together; and
covering the pair of spirally twisted heating wire elements with a tubular sheath made of electrically conductive material;
wherein, when the spirally twisted heating wire elements are supplied with a current of given amplitude flowing in opposite directions in the heating wire elements, the electromagnetic fields from the respective wire elements cancel each other to provide a heating cable substantially free from electromagnetic field.

15. A method of fabricating a heating cable substantially free from electromagnetic field as defined in claim 14, further comprising:
covering the tubular sheath with an insulating jacket.

16. A method of fabricating a heating cable substantially free from electromagnetic field as defined in claim 14, further comprising:
braiding a plurality of small-diameter electrically conductive wires together to from the tubular sheath.

17. A method of fabricating a heating cable substantially free from electromagnetic field as defined in claim 14, wherein:
each heating wire element comprises an electrically insulated wire made of electrically conductive material; and
said method further comprises adjusting an electrical resistance of said wire to produce heat when the wire is supplied with an electric current.

18. A method of fabricating a heating cable substantially free from electromagnetic field as defined in claim 17, wherein:
adjusting an electrical resistance of each heating wire element comprises adjusting a diameter of each said wire element.

19. A method of fabricating a heating cable substantially free from electromagnetic field as defined in claim 15, wherein:
covering the tubular sheath with an insulating jacket comprises extruding over the tubular sheath plastic material capable of withstanding and conducting heat generated by and released from the heating wire elements.

20. A method of fabricating a heating cable substantially free from electromagnetic field as defined in claim 19, wherein:
extruding plastic material comprises extruding plastic material selected from the group consisting of: polyethylene and polypropylene.
